(19) United States
(12) Patent Application Publication
(10) Pub. No.: US 2025/0135551 A1
(43) Pub. Date: May 1, 2025

(54) METHOD FOR INFLUENCING COMPONENTS OR ASSEMBLIES IN A 3D PRINTER

(71) Applicant: Laempe Mössner Sinto GmbH, Barleben (DE)

(72) Inventors: Frank WEDEMEYER, Zell im Wiesental (DE); Rudolf WINTGENS, Schopfheim (DE)

(21) Appl. No.: 18/683,118

(22) PCT Filed: Aug. 3, 2022
(86) PCT No.: PCT/DE2022/000088

§ 371 Date: Feb. 12, 2024

(30) Foreign Application Priority Data
Aug. 12, 2021 (DE) 10 2021 004 139.9

(51) Int. Cl. B22F 10/85; B22F 10/30; B28B 1/00; B28B 17/00; B29C 64/393; B33Y 50/02

(52) U.S. Cl. CPC B22F 10/85; B22F 10/30; B28B 1/001; B28B 17/0081; B29C 64/393; B33Y 50/02

(57) ABSTRACT

Methods for influencing components or assemblies in a 3D printer provide for automatic adjustment or modified actuation of components or assemblies in the 3D printer. Control data with parameters, by means of which the production of a 3D structure in a 3D printer is controlled, is generated from input data. Once the 3D structure is produced and measured, a comparison is carried out between the specified input data measurements and the data of the actual measurements, and differences are ascertained. In the event that the differences exceed a specified tolerance threshold, at least one parameter of the control data is modified.

The invention relates to a method for influencing components or assemblies in a 3D printer, in which deviations from 3D structures generated in the 3D printer are determined and in which components or assemblies are subsequently influenced in a 3D printer.

The term influencing components or assemblies in a 3D printer is understood to mean, for example, both a readjustment of components or assemblies in a 3D printer and a change in the control of components or assemblies in a 3D printer. For example, parameters for controlling components or assemblies in a 3D printer, such as the time at which a nozzle in a print head of a 3D printer is activated, can be changed.

Furthermore, a movement speed of assemblies of the 3D printer, which move over the surface of a construction area of a 3D printer, can also be changed. Such assemblies can be working equipment of a 3D printer, such as a means for discharging or applying the particulate building material, a means for smoothing the discharged particulate building material, a means for compacting the particulate building material or a print head for applying a binder.

In addition, an amount of a binder to be metered using a print head can be increased or reduced, or a cleaning process can be initiated, for example in the event that it is determined that changes in the dosage of the binder do not have the expected effect.

The concept of influencing components or assemblies also includes a change in the amount of particulate building material applied to a construction area.

In addition, the selection or number of used or unused nozzles in a print head that applies a binder can also be changed.

The present invention in particular provides a solution with which an automated influence on components or assemblies in a 3D printer can be realized.

It is known to use so-called 3D printing or a so-called 3D printing process to produce individual or series components, workpieces or shapes. With such printing processes, three-dimensional components or workpieces are produced in layers.

The structure is computer-controlled from one or more liquid or solid materials according to specified dimensions and shapes. Specifications for the components or workpieces to be printed can, for example, be provided by so-called computer-aided design systems (CAD).

When printing 3D structures or 3D components, physical or chemical hardening processes or a melting process take place in a particulate building material, which is also known as a molding material. Building materials or molding materials such as plastics, synthetic resins, ceramics, unsolidified sediments such as minerals or sand and metals are used as materials for such 3D printing processes.

When implementing 3D printing processes, various manufacturing processes are known.

However, several of these process sequences include the process steps shown below as examples:
Partial or full-surface application of particulate building material, also referred to as particulate material or powdery building material, to a so-called construction field in order to form a layer of non-solidified particulate material, whereby the partial or full-surface application of particulate building material involves the discharge and smoothing of the particulate building material includes;
Selectively solidifying the applied layer of non-solidified particulate building material in predetermined areas, for example by selectively compacting, printing or applying treatment agents, such as a binder, using a print head or the use of a laser;
Repetition of the previous process steps in a further layer level to build up the component or workpiece layer by layer. For this purpose, it is intended that the component or workpiece, which is built up or printed in layers on the construction field, is lowered with the construction field by one layer level or layer thickness or that the 3D printing device is raised by one layer level or layer thickness relative to the construction field before a new one Layer is applied over part or all of the surface;
Subsequent removal of loose, unsolidified particulate building material surrounding the manufactured component or workpiece.

A particulate building material is generally understood to be a collection of individual particles of a substance or a mixture of substances, with each particle having a three-dimensional extent. Since these particles can predominantly be understood as round, oval or even elongated particles, it is possible to specify an average diameter for such a particle, which is usually in the range between 0.1 mm and 0.4 mm. Such a particulate building material can have fluid properties.

Various methods for producing a 3D structure or for discharging and applying particulate building material to a construction area to produce a 3D structure are known from the prior art.

From DE 10117875 C1 a method and a device for applying fluids and their use are known.

The method for applying fluids relates in particular to particulate material which is applied to an area to be coated, with the fluid being applied to the area to be coated in front of a blade, viewed in the direction of forward movement of the blade, and then moving the blade over the applied fluid becomes.

The object is to provide a device, a method and a use of the device with which the most even distribution of fluid material on an area to be coated can be achieved.

To solve this, it is provided that the blade performs an oscillation in the manner of a rotary movement. The oscillating rotary movement of the blade fluidizes the fluid applied to the area to be coated. This not only allows particle material that has a strong tendency to agglomerate to be applied as evenly and smoothly as possible, but it is also possible to influence the compression of the fluid through the vibration.

In a preferred embodiment, it is provided that the fluid is applied to the area to be coated in excess, so that due to the constant movement of the blade, which oscillates in the manner of a rotary movement, the excess fluid, seen in the forward movement direction of the blade, is in front of the Blade homogenized in a roller formed from fluid or particulate material by the forward movement of the blade. This allows any cavities between individual particle clumps to be filled and larger clumps of particle material to be broken up by the roller movement.

A disadvantage of this known prior art is that there is usually no testing or quality control of the generated 3D structures for deviations from specified dimensions.

In the event that quality control of the generated 3D structures is carried out, for example, by measuring the generated 3D structures, the detected deviations from predetermined dimensions of the 3D structures can usually only be corrected by mechanically readjusting components or assemblies of the 3D printer become.

However, such mechanical readjustments are usually complex because, for example, it is sometimes necessary to disassemble the 3D printer in order to reach the components or assemblies to be adjusted. In addition, such readjustments also cause the 3D printer to come to a standstill, i.e. an interruption in the creation of a 3D structure in the 3D printer.

This is particularly disadvantageous in areas in which very tight tolerances are specified in the production of 3D structures. Such tolerance ranges are, for example, with specified maximum deviations between +0.3 mm and −0.3 mm. Consequently, a manufactured 3D structure may, for example, be up to 0.3 mm larger or up to 0.3 mm smaller in length in order to adhere to the specified narrow tolerance.

From DE 10 2018 115 432 A1 a system and a method for improved additive production are known. During manufacturing, problems may occur in creating a 3D object based on a variety of factors, which may result in the 3D object being unusable. To avoid such problems, a device is provided which is in direct or indirect communication connection with one or more additive manufacturing machines that use one or more construction parameters. The device is set up to analyze a plurality of structural information relating to the part or the 3D object. The device is also set up to check whether one or more differences between the pre-existing data and the non-pre-existing data lead to a deviation or an improvement of the 3D object. In addition, as a result of the test carried out, one or more structure parameters of the 3D object can be automatically modified.

US 2013/0 314 504 A1 discloses a method for imaging at least one three-dimensional component that is produced by a generative manufacturing process. US 2013/0 314 504 A1 also relates to a device for carrying out such a method. The object of the present publication is to create a method for imaging at least one component manufactured by a generative manufacturing process, the method enabling an improved assessment of the quality of the manufactured component. A further object is to provide a suitable device for carrying out this method.

An embodiment of the method for imaging at least one three-dimensional component, which is produced by a generative manufacturing process, comprises at least the steps of
Determining at least two layer images of the component during its production by a detection device which is designed to detect a spatially resolved measurement variable that characterizes the energy input into the component;
Generating a three-dimensional image of the component based on the determined layer images by a computing device; and
Displaying the image through a display device.

The method therefore makes it possible to record the energy input into the component during its production in a spatially resolved manner. The component can, for example, be a component for a thermal gas turbine, for an aircraft engine or the like.

The WO 2016/094 827 A1 discloses a system, a device and a method for monitoring a three-dimensional printing process. The three-dimensional printing process can be monitored on site and/or in real time. Monitoring the three-dimensional printing process can be done non-invasively. A computer control system may be coupled to one or more detectors and signal processing units to control the generation of a three-dimensional object formed by the three-dimensional printing.

US 2019/0 009 472 A1 discloses a method for in-process inspection of a 3D printed part in a 3D printer, which is a filament extrusion printer. For substantially each envelope volume, a toolpath can be generated for depositing a print material envelope corresponding to the envelope volume. The toolpaths that define the print material shells can be transferred along with identification for application by a 3D printer. In another aspect, in a method for in-process print calibration of a 3D printer, a distance measuring scanner may be carried on a shared carriage along with a print material deposition head.

According to the state of the art, there is therefore no alternatively precise and effective possibility of suitable quality control or quality assurance during the generation of 3D structures.

There is therefore a need for an improvement in the known state of the art and thus for an improved method for influencing components or assemblies in a 3D printer.

The object of the invention is to provide a method for influencing components or assemblies in a 3D printer, with which an automated readjustment or a changed control of components or assemblies in a 3D printer is achieved. The process is also intended to reduce the downtime of a 3D printer and improve the quality of the 3D structures produced.

The task is solved by a method for influencing components or assemblies in a 3D printer with the features according to claim 1 of the independent patent claims. Further developments are specified in the dependent patent claims.

According to the prior art, 3D structures generated in a 3D printer can be measured after they have been created in the 3D printer in order to determine deviations between the specified dimensions and the dimensions of a 3D structure generated by the 3D printer. Such deviations represent the difference between the data for the dimensions of a 3D structure to be generated, for example generated using a computer-aided design system, and the actual dimensions of the 3D structure generated.

The reason for such differences is, for example, the mechanical tolerances of the 3D printer or can also be caused by a changing quality of the particulate building material, which can have agglomerates or “gaps” due to uneven compression.

In addition, one or more clogged nozzles of a print head that is supposed to apply a binder can lead to differences between dimensions. Warping of the 3D structure during curing or drying or inadequate cleaning of the 3D structure after production can also be the cause of differences between the dimensions.

When measuring a generated 3D structure, for example, dimensions of external or internal contours of the 3D structures can be determined using conventional measuring devices and methods known from the prior art. Such measurement can extend over one or more dimensions of the generated 3D structure, such as its height, its width and its length.

According to the prior art, for example, some measurements or dimensions are determined and noted, for example, in the form of a predetermined table. These dimensions of the generated 3D structure, noted in the specified table, are then compared with comparison dimensions or reference dimensions. Such reference dimensions correspond, for example, to the specified dimensions of the computer-aided design system.

In one case, such determined dimensions and reference dimensions can also be so-called 3D data, which are also checked for deviations from one another.

Such a comparison of a certain number of, for example, actual dimensions and reference dimensions can be carried out by a suitably qualified operator of a 3D printer. This must then decide, for example, while adhering to known tolerance limits, whether the differences between these dimensions exceed a certain tolerance and whether the required quality of the generated 3D structures has been achieved or not.

If this required quality is not achieved, appropriate measures must be taken to readjust components or assemblies in the 3D printer in order to meet the specified quality requirements.

A disadvantage of this method known from the prior art is that this comparison or evaluation of the dimensions by an operator can lead to misinterpretations, as a result of which a 3D printer is stopped and dismantled, checked or readjusted without that such a readjustment would have been necessary.

According to the present method, it is therefore provided that the comparison of a certain number of actual dimensions and reference dimensions is carried out automatically. This occurs regardless of the fact that, for example, each dimension is a single value such as a height, a width or a length, or that dimensions are in the form of three-dimensional data. For example, starting from a reference point or a reference coordinate system, such three-dimensional data has values such as an X, a Y and a Z component in a three-dimensional coordinate system. For example, by specifying 3D data, i.e. an X, a Y and a Z component, a specific point on the surface of a generated 3D structure can be described.

This automated comparison of the specific number of actual dimensions and reference dimensions determines respective differences between the compared dimensions, which may be positive deviations or negative deviations.

The automated comparison can also be carried out taking into account specified tolerances or tolerance limits. These tolerances or tolerance limits can also be specified for positive deviations and for negative deviations. In one variant, these tolerance limits for the positive deviations are the same size as the tolerance limits for the negative deviations. In an alternative variant, these tolerance limits for the positive deviations are not the same size as the tolerance limits for the negative deviations. In this way, for example, different conditions can apply to a so-called oversize than to a so-called undersize in order to correspond to the specified quality specifications.

According to the present method, it is further provided that detected deviations or detected deviations that lie above the specified tolerance limits are eliminated by automatically influencing or readjusting components or assemblies of the 3D printer.

It is envisaged that a readjustment can be a mechanical change, for example, in the position or arrangement or orientation of a component or an assembly.

For this purpose, the 3D printer must be equipped with appropriate options for automatic readjustment. In this way, for example, a readjustment of a position and/or an alignment of a print head of a 3D printer could take place.

In order to eliminate deviations that lie above the specified tolerance limits, it is further provided that a thickness of a layer of the particulate building material to be applied is changed or that an amount of a binder to be metered using a print head is increased or reduced. The composition of the particulate building material or the binder could also be changed. As an alternative to these measures, cleaning or intermediate cleaning of a print head can reduce deviations that occur.

Alternatively, it is provided that no mechanical change is made to a position, an arrangement or an orientation of a component or an assembly and instead, for example, the data generated by the computer-aided design system is influenced to generate a 3D structure.

For example, a time at which a nozzle of a print head is activated, i.e. a control time parameter, can be changed. If the print head carries out a uniform movement over the surface of the construction area at a constant distance from the surface of the construction area, the time at which a nozzle of a print head is activated changes the position of the impact of the binder drop released through this nozzle on the surface of the construction area. In this way, it is possible to effect a necessary readjustment of the accuracy of the dimensions of the 3D structure to be generated by changing the control time parameter.

The deviations or deviations detected according to the method, which are above the specified tolerance limits, thus lead to a shift in the control time parameter of one or more nozzles of one or more print heads of the 3D printer in order to reduce or eliminate the deviations.

In addition to influencing the control time parameter, a change in the speed parameter at which a component or an assembly, such as a print head, moves over the surface of the construction area can also be provided.

In an alternative case, both an influence on the control time parameter and a change in the speed of the print head can be provided.

Another possibility is to change a selection of nozzles used in a print head. For example, nozzles can be switched on or off in order to increase or reduce or shift the effective width when a binder is applied to a particulate building material on the construction field by a print head.

In order to record the actual dimensions of a generated 3D structure, it is intended to carry out this acquisition by means of a three-dimensional measurement or a 3D scan, which is required for a comparison of the actual dimensions of the generated 3D structure with the predetermined dimensions, i.e. the reference dimensions Data is generated in the form of three-dimensional 3D data.

This provided 3D data, which depicts the actual dimensions of the generated 3D structure at selected points on the surface of the 3D structure, is compared with the specified dimensions or reference dimensions, which are also available as 3D data, and such differences between the actual ones Dimensions and the reference dimensions are determined.

The capture of actual dimensions of a created 3D structure using a 3D scan offers the possibility of automatically generating the data digitally and thus immediately transferring it to the program implementing the method in question. This program also carries out the comparison of dimensions in digital form. The program observes specified tolerances during this comparison and only outputs errors if they lie outside the specified tolerance limits. On the basis of these detected errors, for example, the control time parameter of one or more nozzles in a print head or in several print heads is changed in order to reduce or eliminate the detected differences or deviations at a specific point on the surface of the generated 3D structure.

A program implementing the present method is executed, for example, in a central control unit of the 3D printer. This central control unit also controls the process of creating the 3D structure on the basis of the data transferred to it about the dimensions of the 3D structure to be created. Such data can be generated, for example, by a computer-aided design system and transferred to the central control unit. The central control unit therefore has or generates parameters for controlling the 3D printer, such as the parameter of the activation time of a nozzle or the parameter of the movement speed of an assembly over the construction area. This means, for example, that the control time parameter of a nozzle can be influenced by the central control unit. This parameter control time of a nozzle can be shifted in time by the central control unit compared to its predetermined value of the control time, so that the shifted control time is before or after the predetermined value of the control time. The direction of this shift depends on the direction of the determined deviation in dimensions.

It is intended that several or every 3D structure created is measured by a three-dimensional measurement or by means of a 3D scan. In contrast to a single scan, a statement can be made as to whether an error that occurred or a deviation that was too large was a single random error or whether there was a systematic deviation.

In this way, for example, if a one-time error or a one-off excessive deviation occurs, a different error procedure can be started than if systematic errors or excessively large deviations occur.

For example, a parameter such as the activation time of a nozzle of a print head can only be changed if systematic errors occur.

It is also planned that if systematic errors occur, an average value is formed of the detected deviations and that a parameter such as a control time of a nozzle of a print head is automatically changed on the basis of this specific average value.

The previously explained features and advantages of this invention can be better understood and evaluated after careful study of the following detailed description of the preferred, non-limiting example embodiments of the invention herein with the accompanying drawings, which shows:

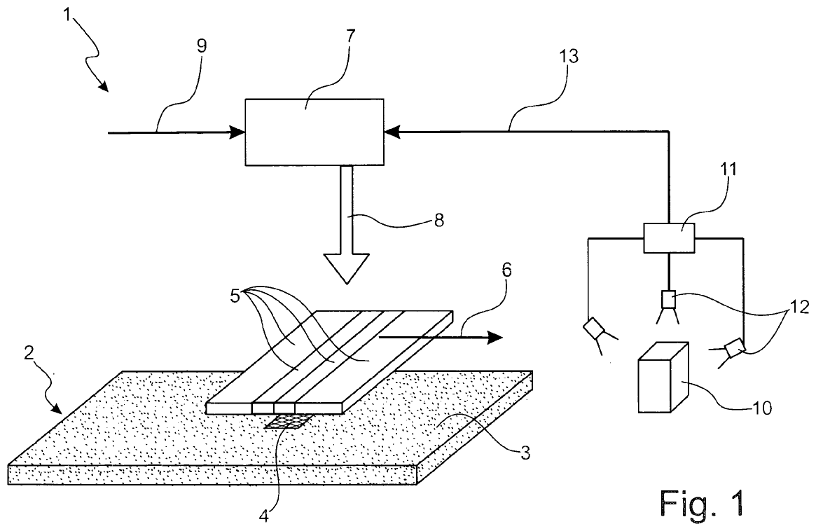

FIG. 1: a schematic diagram of an exemplary embodiment of the invention,

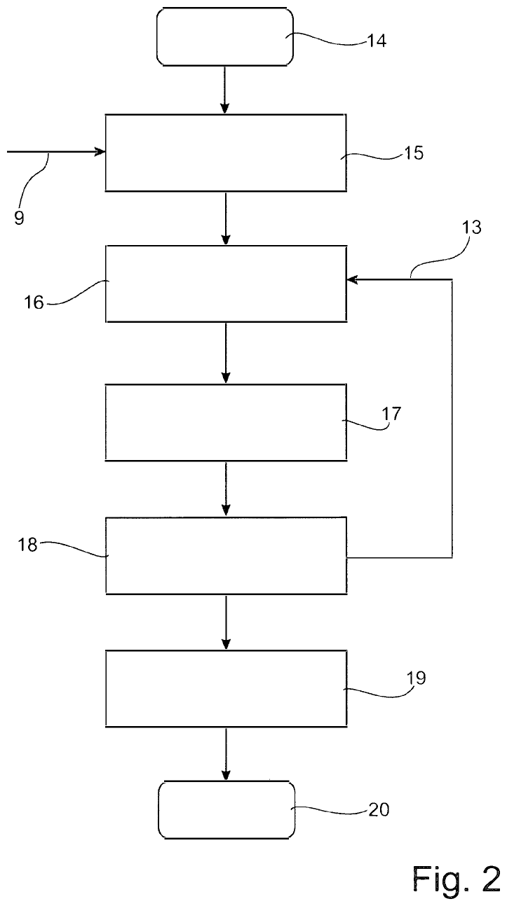

FIG. 2: a representation of a basic sequence of the method, and

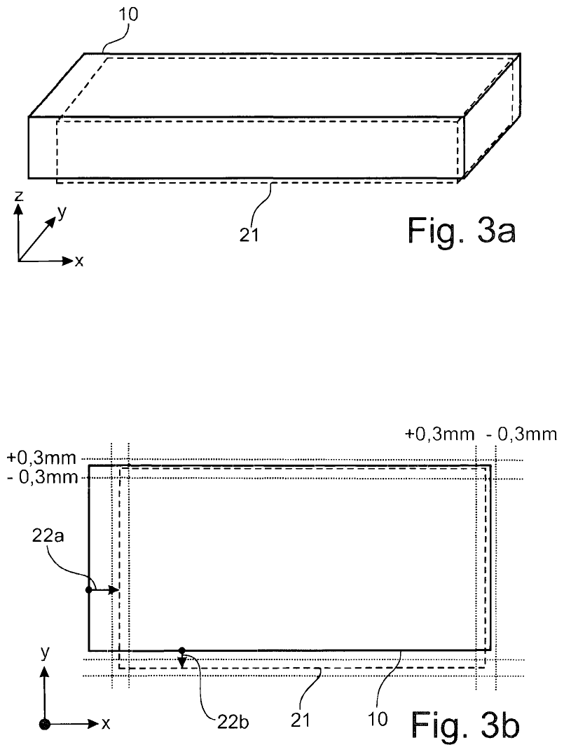

FIGS. 3a and 3b: each a comparison of a 3D structure created in 3D printing with an associated reference.

A schematic diagram of an exemplary embodiment of the invention is shown in FIG. 1.

The 3D printer 1, which is only shown in principle, has a construction area 2. In the construction field 2 there is particulate building material 3 in loose form and in a partial area in a selectively solidified form 4 of the particulate building material 3. In this partial area, in which the particulate building material 3 is in the solidified form 4, the 3D structure is generated.

Above the construction area 2, the working equipment 5 of the 3D printer is moved, for example, in the direction of movement 6 shown and at a constant distance from the surface of the construction area 2. Such working equipment 5 of the 3D printer can, for example, be a means for discharging or applying the particulate building material 3, a means for smoothing the discharged particulate building material 3, a means for compacting the particulate building material 3 or a print head for applying a binder.

In an area of the working medium 5, at least one print head with at least one nozzle is arranged, by means of which, for example, a drop of a binder for selectively solidifying the particulate building material 3 is applied or metered onto the surface of the building field 2.

A central control unit 7 controls all work processes within the 3D printer 1 and transmits control data 8 to the work equipment 5 to generate a 3D structure 10. This control data 8 also contains parameters which, for example, are a movement speed of the work equipment 5 in the exemplary direction of movement 6 or a Determine the control time for a nozzle in a print head of a working medium 5.

To generate a 3D structure 10, input data 9 is transmitted to the central control unit 7, which describes, for example, the dimensions of the 3D structure 10 to be generated. This input data 9 can also describe or contain the dimensions of the 3D structure 10 to be created for each layer of the 3D structure 10 to be created. Using this input data 9, the central control unit 7 generates the control data 8 with its parameters.

For example, after the 3D structure 10 has been generated, it is measured three-dimensionally in order to obtain data about the actual dimensions of the 3D structure created. This measurement can be done, for example, using a 3D scanning arrangement 11. For this purpose, the 3D scanning arrangement 11 has, for example, several sensors 12, which scan the generated 3D structure 10 from several directions and thus generate 3D data 13 for individual points on the surface of the generated 3D structure 10. This 3D data 13 is transmitted to the central control unit 7.

In the central control unit 7, the default data or the input data 9 are compared with the 3D data 13 generated in the scan. Deviations between the specified dimensions for the 3D structure to be created and the dimensions of the 3D structure created by the 3D printer are thus determined. Such deviations represent the difference between the input data 9 generated by a computer-aided design system and the 3D data 13 generated in the scan of the actual dimensions of the generated 3D structure.

On the basis of these determined differences, for example, a control time of a nozzle of a print head in the 3D printer 1 can be changed. By shifting the timing of the activation of a nozzle, the partial area in which the particulate building material 3 is present in a selectively solidified form 4 on the construction area 2 is changed or shifted. This shift also changes the dimensions of the interior or exterior contours of the 3D structure being created.

In this way, a procedural influence on components or assemblies in a 3D printer is achieved to improve the accuracy of the 3D structure 10 to be generated.

During this process, specified tolerances for permissible differences or deviations can also be observed. For example, the actuation time of a nozzle is only shifted if a permissible tolerance is exceeded or fallen short of. Different tolerances for different directions of differences or deviations can also be taken into account here. For example, a different tolerance can be specified for an oversize than for an undersize.

FIG. 2 shows a representation of a basic sequence of the method.

After starting the method in step 14, control data 8 with its parameters is generated from the input data 9 in the subsequent processing step 15. This generation of the control data 8 is carried out by means of a central control unit 7, not shown in FIG. 2. The control data 8 generated in this way is transmitted to the work equipment 5 of the 3D printer 1.

Using this control data 8, a 3D structure 10 is generated in the 3D printer 1. The 3-printer 1, the control data 8 and the 3D structure 10 are not shown in FIG. 2.

In the following comparison 16 or comparison step 16, in the event that no 3D structure 10 has yet been generated in the 3D printer 1, there will be no change in the parameters or the control data 8.

Subsequently, in step 17, a 3D structure is generated.

In step 18, a three-dimensional measurement of the generated 3D structure 10 is carried out. Such a measurement can be carried out using methods known from the prior art, which generate corresponding measurement data and can transmit these, for example, as 3D data 13 to the central control unit 7.

In the example in FIG. 1, the three-dimensional measurement is carried out using a 3D scan. Such measurement generates corresponding 3D data 13, which are returned to step 16.

In step 19, the generation and measurement of the generated 3D structure is completed and the method is ended in step 20. Alternatively, the process can also be carried out several times in order to generate several 3D structures one after the other. A corresponding return to the beginning of the process is not shown in FIG.

In the event that corresponding 3D data 13 is returned to step 16, a comparison takes place in step 16. During this comparison, deviations between the specified dimensions and the actual dimensions of the 3D structure 10 generated by the 3D printer are determined and stored as differences or deviations. In such a comparison, the data of the specified dimensions are compared with the data of the actual dimensions.

If a difference or deviation determined during this comparison exceeds a predetermined tolerance limit, at least one parameter of the control data 8 is changed in step 16 in order to reduce or eliminate the detected deviation. Such a parameter is, for example, a time for activating a nozzle in a print head that applies a binder, and several times for several nozzles can also be changed.

Alternatively, without taking a tolerance limit into account, if a deviation is detected between the specified dimensions and the actual dimensions of the 3D structure 10 generated by the 3D printer, at least one parameter of the control data 8 can be changed in step 16 in order to correct the detected deviation reduce or eliminate.

In this case, a further 3D structure is generated in step 17, taking into account the control data 8 adjusted or changed in comparison 16 with its adjusted or changed parameters.

FIGS. 3a and 3b each show a 3D structure 10 produced by 3D printing and an associated reference 21 in comparison of their external dimensions, with FIG. 3a showing a perspective view and FIG. 3b showing a top view.

The reference 21 represents a 3D structure, which is to be created by the process of generating a 3D structure in the 3D printer and has no deviations from the specified dimensions.

The generated 3D structure 10 is the result of generating a 3D structure in the 3D printer and may have undesirable, manufacturing-related deviations from the specified dimensions.

The reference 21 can alternatively only be understood as a data set or as the data of the specified dimensions for the 3D structure to be generated. The reference 21 does not have to be physically present for the present method and the comparison of the data or 3D data.

As can be seen in the example of FIG. 3a, the generated 3D structure 10 has a three-dimensional extent, with an extent in the X direction shown as the length, an extent in the Y direction shown as the width and an extent in the Z direction shown should be referred to as the height of the 3D structure 10.

FIG. 3a shows a basic representation of the generated 3D structure 10 with its associated reference 21, which is intended to illustrate that deviations occur due to manufacturing tolerances, whereby the deviations can only occur in one dimension, in two dimensions or in all three dimensions.

As shown in FIG. 3b using several dot-dot lines, tolerance thresholds for permissible deviations are set. These tolerance thresholds for positive and negative deviations can, for example, be +0.3 mm and −0.3 mm, as shown in FIG. 3b, with no restriction being provided regarding either the value or the symmetry of the deviations.

In the event that the generated 3D structure 10 has an oversize in its length in the X direction, for example, this deviation may only be up to +0.3 mm if specified tolerance limits are used, otherwise the Length of the generated 3D structure 10 not within the specified tolerance threshold.

In the case without the use of predetermined tolerance limits, it is intended to view any difference determined between the predetermined dimensions and the actual dimensions of the 3D structure 10 generated by the 3D printer as a deviation to be corrected and to change at least one parameter of the control data 8 in order to to reduce or eliminate such an established difference for a 3D structure 10 to be subsequently generated.

In the event that the generated 3D structure 10 is undersized in its length in the X direction, for example, this deviation may only be up to −0.3 mm, otherwise the length of the generated 3D structure 10 is not within the specified tolerance threshold.

If, for example, the tolerance threshold of the length of the generated 3D structure 10 of a maximum of +0.3 mm is exceeded, as shown in the left part of FIG. 3b as deviation 22a, according to the method, at least one parameter of the control data 8 is changed, the change being this Parameters are carried out in such a way that the difference for a 3D structure 10 to be subsequently generated is reduced or eliminated.

The deviation 22a is shown as a point on the left edge of the body of the generated 3D structure 10 shown in FIG. 3b because the present method can carry out the comparison of the data or 3D data point by point. In this way, for example, various deviations on the left edge of the body of the 3D structure 10, which are not shown in FIG. 3b, can be recognized point by point, processed point by point and corrected differently by point.

A simplification of the method can be that only one point of a deviation, such as the deviation 22a or an average value, formed from two, three or four deviations found on the left edge of the body, is used to change at least one parameter according to the method.

In the example of FIG. 3b, a time at which a nozzle of a print head is activated, i.e. the parameter control time of a nozzle, can be changed. It is assumed that a print head (not shown) applying a binder is moved from left to right across the construction field in FIG. 3b when producing the 3D structure 10 and has a nozzle associated with the point of deviation 22a. If, in this case in FIG. 3b, the time at which the corresponding nozzle of the print head is activated is selected later, the left edge of the body or the point of deviation 22a in FIG. 3b will shift to the right. In this way the deviation 22a becomes smaller. If the time at which the nozzle is activated is shifted accordingly, it is achieved that the deviation 22a no longer occurs, since the left edge of the body is now, for example, with a deviation of +0.2 mm within the specified tolerance threshold, which is not shown in FIG. 3b.

In addition, it can be provided that in the event that a deviation of a point or a body edge of the generated 3D structure 10 lies within the tolerance threshold or is several times, for example, at the limit of the tolerance threshold at +0.3 mm, by a qualified operator Change at least one parameter is carried out independently of the method.

In addition, according to the method, it is provided that the comparison of the 3D structure 10 generated in the 3D printer and the associated reference 21 takes place layer by layer, analogous to the layer by layer generation of the 3D structure. In this way, various deviations in different layers can be recognized and reduced or eliminated according to the method.

A difference in the deviations in different layers when producing the 3D structure 10 can be caused, for example, by the particulate building material or the binder for selectively solidifying the particulate building material being applied in different directions of movement of the working equipment of the 3D printer. This is the case, for example, if the particulate building material and/or the binder are applied both in a first direction of movement of the working equipment of the 3D printer over the construction field and in a second direction of movement of the working equipment of the 3D printer over the construction field, the second Direction of movement is directed opposite to the first direction of movement.

As a further example of a difference in the dimensions of the 3D structure 10 produced in 3D printing and the associated reference 21, the deviation 22b is shown as an example in FIG. 3b. In this case, the permissible tolerance threshold of −0.3 mm regarding the width of the generated 3D structure 10 was undershot. In this case too, a change in accordance with the method is made to at least one parameter in order to shift the deviation 22b or the entire lower body edge of the 3D structure 10 in FIG. 3b and thus reduce or eliminate differences for a 3D structure 10 to be subsequently generated. In this case, it can be provided that nozzles of a print head that applies a binder are activated or switched on, which were not previously used. This control of one or more additional nozzles increases the width of the 3D structure 10 to be created and thus eliminates the undersize in the width that has occurred.

Switching on or off nozzles of a print head for a 3D structure to be subsequently created also represents a change in the activation time of a nozzle when generating a 3D structure 10.

### LIST OF REFERENCE SYMBOLS

1 3D printer
2 construction area
3 particulate building material
4 selectively solidified form of the particulate building material
5 work equipment
6 direction of movement
7 central control unit
8 control data/parameters
9 input data
10 3D structure
11 3D scanning arrangement
12 sensors
13 3D data
14 start
15 Processing step/generation of control data
16 comparison
17 Creation of the 3D structure
18 Measured
19 3D structure finished and measured
20 end
21 reference
22a, 22b deviation

1.-8. (canceled)

9. A method for controlling a 3D printer, the method comprising:
receiving input data specifying predetermined dimensions for a 3D structure to be produced;
establishing control data for operating the 3D printer based on the received input data;
measuring, in three-dimensions, a first 3D structure generated by the 3D printer based on the control data;
determining a first difference between the specified predetermined dimensions of the input data and the measured dimensions of the first 3D structure; and
if the first difference exceeds a predetermined tolerance threshold, changing at least one parameter of the control data such that for a subsequent 3D structure generated by the 3D printer using the changed control data, a second difference between the specified predetermined dimensions of the input data and the measured dimensions of the subsequent 3D structure is less than the first difference,
wherein the changed parameter of the control data is at least one of:
a time of control of a nozzle in a print head of a 3D printer; or
a movement speed of at least one component of the 3D printer, wherein the at least one component of the 3D printer is at least one of:
a means for discharging the particulate building material;
a means for smoothing the discharged particulate building material; or
a means for compacting the particulate building material.

10. The method according to claim 1, wherein the input data includes predetermined dimensions for one or more individual layers of a 3D structure to be produced.

11. The method according to claim 1, wherein the control data controls operation of the at least one component of the 3D printer.

12. The method according to claim 1, wherein the measured dimensions of the first 3D structure are determined at a plurality of points on a surface of the first 3D structure.

13. The method according to claim 1, wherein the first difference and the second difference are determined in three-dimensions.

14. The method according to claim 1, wherein the predetermined tolerance threshold is a first threshold when the first difference is positive and is a second threshold when the first difference is negative, the first threshold being different from the second threshold.

15. The method according to claim 1, wherein the predetermined tolerance threshold is between +0.5 mm and −0.5 mm.

16. The method according to claim 1, wherein the first difference and the second difference are each determined point by point.
